(19) United States
(12) Patent Application Publication
(10) Pub. No.: US 2019/0005156 A1
(43) Pub. Date: Jan. 3, 2019

(54) DATA FLOW VISUALIZATION SYSTEM

(71) Applicant: Anvilcraftworks Pty Limited, New South Wales (AU)

(72) Inventors: Jarrod Smith, Auckland (NZ); Iain Greenhalgh, New South Wales (AU)

(21) Appl. No.: 16/014,375

(22) Filed: Jun. 21, 2018

(30) Foreign Application Priority Data
Jun. 28, 2017 (AU) 2017902490

(51) Int. Cl. G06F 17/30; G06Q 50/00

(52) U.S. Cl. CPC G06F 17/30994; G06Q 50/01; G06F 17/30867

(57) ABSTRACT

A method system and method for data visualization. The method comprises: receiving, via a network, data describing Twitter messages related to one or more entities; determining one or more communication characteristics of the data for each of the entities; generating simulation parameters for each of the entities, the simulation parameters relating to emission rates of the data corresponding to each entity, the simulation parameters being determined from the one or more communication characteristics; and implementing a simulation reflecting data flow of the Twitter messages for each of the entities at the determined emission rates using the simulation parameters.

### CROSS REFERENCE TO RELATED APPLICATIONS

This application claims the benefit of Australian Patent Application No. 2017902490, having a filing date of Jun. 28, 2017, the disclosure of which is incorporated herein by reference.

### FIELD OF THE INVENTION

The present invention relates generally to data processing for data related to Twitter. In particular, the present invention relates to a system and method for visually representing information relating to Twitter, and representing the social media data to reflect meaningful temporal or sequential ordering in a manner understandable to a user.

### BACKGROUND OF THE INVENTION

Social media has become increasingly popular and relevant to real-life events. In particular, Twitter provides information relating to topics of interest of particular users. Given the large amounts of social media data generated as tweets, the overall nature and meaning of trends associated with the tweets can be difficult for a user to accurately determine. The continuous nature of Twitter posts can be difficult to accurately understand by a user in near real-time, or in a meaningful way. Twitter analysis applications currently available typically relate to general trends rather than to particular or narrow topics or queries of interest to a given user. Available social media monitoring and analysis tools are often cumbersome, and do not easily customise to a user's particular requirements, or readily provide understandable data. Further, many users monitor Twitter data using a portable device such as a smartphone, which may have limited processing capability and for which applications for analysing large amounts of data are typically not available.

Visual representations of this data have been largely limited to traditional graphs and charts, offering only rigid overviews of certain pre-determined gross aspects of the data, with limited insight into specifics or the ability to discover emergent patterns. There is an absence of tools that run on portable devices that allow users to do exploratory analysis of high-volumes of social media data quickly and intuitively in a user's specific areas of interest.

### SUMMARY OF INVENTION

Is it an object of the present invention to substantially overcome, or at least ameliorate, at least one disadvantage of present arrangements.

The arrangements described generally relate to methods and systems for representing sequential and temporal ordering of Twitter data in a visual manner to a user. The arrangements described further relate to simulating directional and temporal aspects of Twitter information for a user.

One aspect of the present disclosure provides a method, comprising: receiving, via a network, data describing Twitter messages related to one or more entities; determining one or more communication characteristics of the data for each of the entities; generating simulation parameters for each of the entities, the simulation parameters relating to emission rates of the data corresponding to each entity, the simulation parameters being determined from the one or more communication characteristics; and implementing a simulation reflecting data flow of the Twitter messages for each of the entities at the determined emission rates using the simulation parameters.

Another aspect of the present disclosure provides a computer readable medium having a computer program stored thereon, the program comprising: code for receiving, via a network, data describing Twitter messages related to one or more entities; code for determining one or more communication characteristics of the data for each of the entities; code for generating simulation parameters for each of the entities, the simulation parameters relating to emission rates of the data corresponding to each entity, the simulation parameters being determined from the one or more communication characteristics; code for implementing a simulation reflecting data flow of the Twitter messages for each of the entities at the determined emission rates using the simulation parameters.

Another aspect of the present disclosure provides a handheld device, comprising: a display, a memory, a processor, wherein the processor is executes code stored on the memory for: receiving, via a network, data describing Twitter messages related to one or more entities; determining one or more communication characteristics of the data for each of the entities; generating simulation parameters for each of the entities, the simulation parameters relating to emission rates of the data corresponding to each entity, the simulation parameters being determined from the one or more communication characteristics; reproducing, on the display, a simulation reflecting data flow of the Twitter messages for each of the entities at the determined emission rates using the simulation parameters

Other aspects are also described.

### BRIEF DESCRIPTION OF DRAWINGS

At least one embodiment of the present invention will now be described with reference to the drawings, in which:

FIGS. 1A and 1B collectively form a schematic block diagram representation of an electronic device upon which described arrangements can be practiced;

FIG. 2 shows a schematic flow diagram of a method of visualising data flow;

FIG. 3 shows a schematic flow diagram of a method of generating data points, as used in the method of FIG. 2;

FIG. 4 shows a schematic flow diagram of a method of generating simulation parameters, as used in the method of FIG. 2;

FIG. 5 shows a schematic flow diagram of a method of determining simulation particles as used in the method of FIG. 4;

FIG. 6 shows a schematic flow diagram of a method of generating particular positions as used in the method of FIG. 4;

FIG. 7 shows a screenshot of a GUI display generated using the method of FIG. 2;

FIG. 8 shows a screenshot of a GUI display generated using the method of FIG. 2 including a menu;

FIG. 9 shows another screenshot of a GUI display generated using the method of FIG. 2;

FIG. 10 shows an example software architecture for visualising data flow;

FIG. 11 shows an example graphical user interface for a user to enter a search for an emitter;

FIGS. 12A to 12D show example graphical user interfaces for searching for an emitter using trends;

FIG. 13 shows an example graphical user interface for a user to enter a search for an attractor; And

FIG. 14 shows a texture used for rendering.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

As discussed above, a need exists to derive meaningful data analysis from large amounts of social media data such as Twitter posts and provide the data in a way that is useful and understandable to a user. The arrangements described relate to a system and method of rapidly arranging, understanding and explore large sets of Twitter data, having meaningful temporal or sequential ordering, and generating and displaying a simulation reflecting the temporal and sequential order, along with other characteristics of the data.

A need exists in existing social media systems for a method of determining meaningful temporal or sequential information in relation to social media data. Merely indicating that a hashtag or a particular account is trending, for example, does not provide a meaningful indication of how that data is trending relative to other users, or direction or intent of associated Twitter data. A need exists to address this deficiency present in currently available social media analysis tools.

A Twitter post or tweet is a message submitted by an owner or originator via a user account. The message is typically in form of a text string of up to 140 characters in length, or can relate to a digital image or video sequence. The arrangements described relate to visualising data relating to text tweets only. The submitted message is distributed to contacts linked to the user account. The contacts can further share the tweet if desired, often referred to as “retweeting”. Many users use a hash symbol as a designator for categorizing messages, in a practice known as “hashtagging”. For example, the phrase “#election” may be used to indicate a tweet relating to an election. A hashtag makes a message searchable for other Twitter users and provides a mechanism for grouping messages posted.

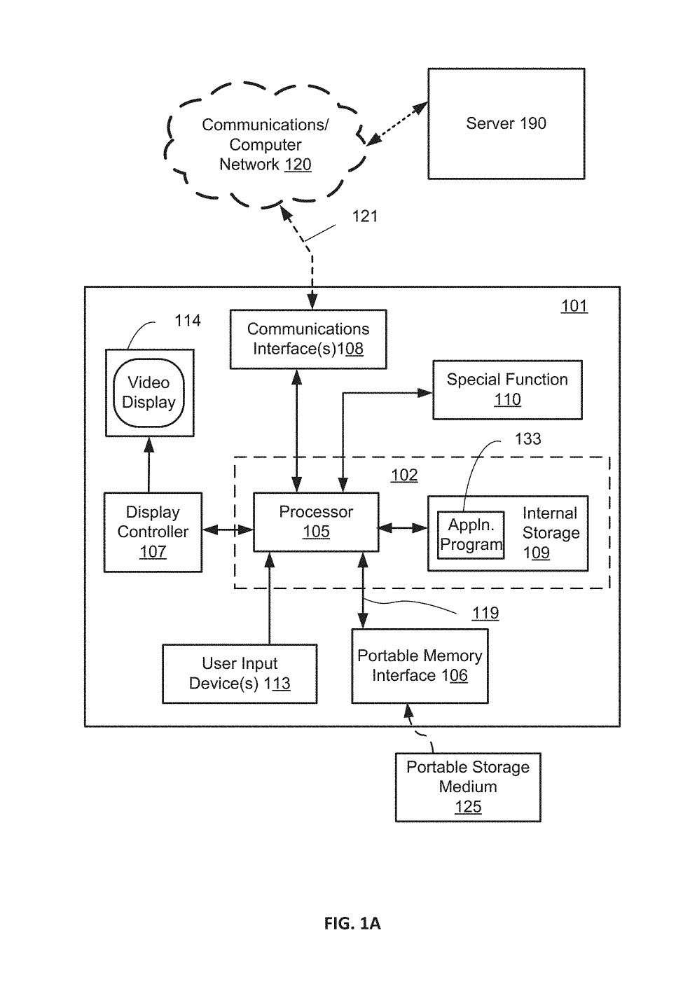

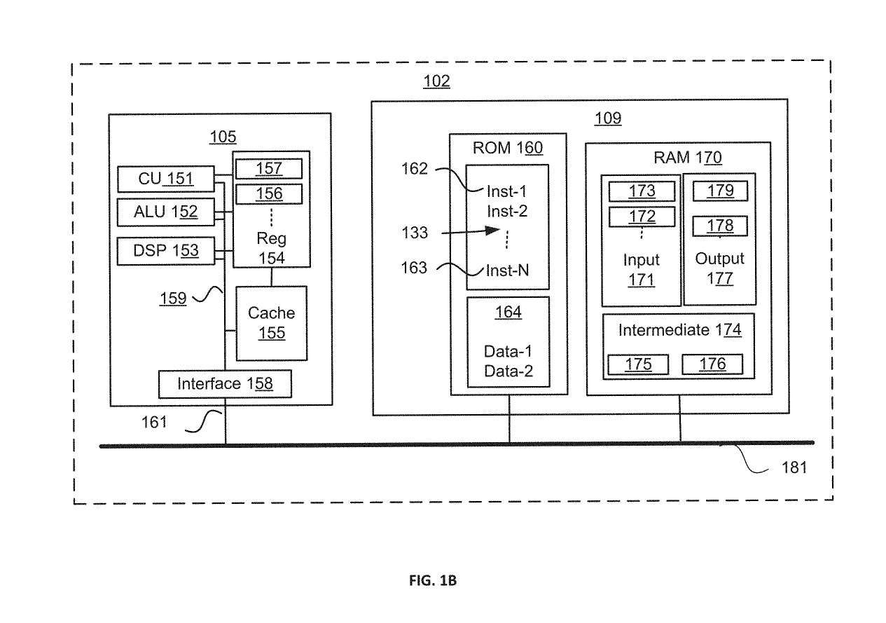

FIG. 1A shows a system 100 including a general purpose electronic device 101 on which the methods described may be implemented. The general purpose device 101 is typically a portable (mobile) or handheld user device, such as a smartphone, a tablet computer, laptop, or the like, in which resources are limited. However, the device 101 can also be a user device in which resources are not limited such as a desktop computer. The device 101 is in communication with a server computer 190, which relates to a social media platform. In the arrangements described, the server 190 relates to a Twitter server, from which information relating to Twitter posts may be received. Data is transmitted between the server 190 and the device 101 via a network 120, for example, using a HTTP protocol.

The methods described herein provide a solution by which a user of the electronic device 101 can designate points of interest, referred to as “emitters” or “entities” associated with Twitter data or traffic. The arrangements described request data associated with the relevant Twitter traffic and use the requested data in such a manner as to provide the user with a visual representation of data flow. The visual representation effectively provides a simulation relating to direction, speed and/or content of the Twitter data that is intuitively understandable to a user.

The arrangements described harness the relatively large amounts of data for different entities in the large data set, and show how much of the data does or does not match a user query. In the context of the arrangements described, an entity relates to a user point of interest, also referred to as an endpoint. Endpoints are typically derived from a user search, as described further below. An entity can relate to an endpoint that emits or attracts Twitter data.

Deriving meaningful data from large sets of social media data faces a number of difficulties. Firstly, high performance is required for a simulation that runs in near real time on a device such as a smartphone sending requests to and receiving responses from the social media data place. Further, a consistent visual comparison needs to be provided for data from each emitter or entity in relation to all other entities involved. Relevant information present in a large set of data is recognised and determinations made to provide an interactive visualization of data in a manner that is intuitive and straightforward to a user viewer.

FIGS. 1A and 1B collectively form a schematic block diagram of the general purpose electronic device 101 including embedded components, upon which the methods to be described are desirably practiced. The electronic device 101 may as described above, be a personal device in which processing resources are limited. Nevertheless, the methods to be described may also be performed on higher-level devices such as desktop computers, server computers, and other such devices with significantly larger processing resources.

As seen in FIG. 1A, the electronic device 101 comprises an embedded controller 102. Accordingly, the electronic device 101 may be referred to as an “embedded device.” In the present example, the controller 102 has a processing unit (or processor) 105 which is bi-directionally coupled to an internal storage module 109. The storage module 109 may be formed from non-volatile semiconductor read only memory (ROM) 160 and semiconductor random access memory (RAM) 170, as seen in FIG. 1B. The RAM 170 may be volatile, non-volatile or a combination of volatile and non-volatile memory.

The electronic device 101 includes a display controller 107, which is connected to a video display 114, such as a liquid crystal display (LCD) panel or the like. The display controller 107 is configured for displaying graphical images on the video display 114 in accordance with instructions received from the embedded controller 102, to which the display controller 107 is connected.

The electronic device 101 also includes user input devices 113 which are typically formed by keys, a keypad or like controls. In some implementations, the user input devices 113 may include a touch sensitive panel physically associated with the display 114 to collectively form a touch-screen. Such a touch-screen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

As seen in FIG. 1A, the electronic device 101 also comprises a portable memory interface 106, which is coupled to the processor 105 via a connection 119. The portable memory interface 106 allows a complementary portable memory device 125 to be coupled to the electronic device 101 to act as a source or destination of data or to supplement the internal storage module 109. Examples of such interfaces permit coupling with portable memory devices such as Universal Serial Bus (USB) memory devices, Secure Digital (SD) cards, magnetic disks, and the like.

The electronic device 101 also has a communications interface 108 to permit coupling of the device 101 to a computer or communications network 120 via a connection 121. The connection 121 may be wired or wireless. For example, the connection 121 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like.

Typically, the electronic device 101 is configured to perform some special function. The embedded controller 102, possibly in conjunction with further special function components 110, is provided to perform that special function. For example, the device 101 may be a mobile telephone handset. In this instance, the components 110 may represent those components required for communications in a cellular telephone environment. Where the device 101 is a portable device, the special function components 110 may represent a number of encoders and decoders of a type including Joint Photographic Experts Group (JPEG), (Moving Picture Experts Group) MPEG, MPEG-1 Audio Layer 3 (MP3), and the like.

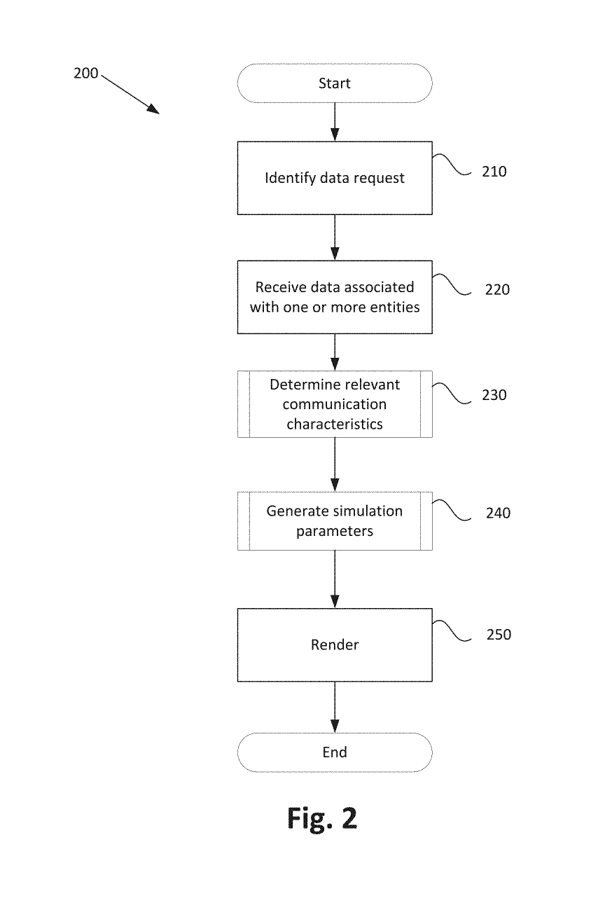

The methods described hereinafter may be implemented using the embedded controller 102, where the processes of FIGS. 2 to 6 may be implemented as one or more software application programs 133 executable within the embedded controller 102. The electronic device 101 of FIG. 1A implements the described methods. In particular, with reference to FIG. 1B, the steps of the described methods are affected by instructions in the software 133 that are carried out within the controller 102. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 133 of the embedded controller 102 is typically stored in the non-volatile ROM 160 of the internal storage module 109. The software 133 stored in the ROM 160 can be updated when required from a computer readable medium. The software 133 can be loaded into and executed by the processor 105. In some instances, the processor 105 may execute software instructions that are located in RAM 170. Software instructions may be loaded into the RAM 170 by the processor 105 initiating a copy of one or more code modules from ROM 160 into RAM 170. Alternatively, the software instructions of one or more code modules may be pre-installed in a non-volatile region of RAM 170 by a manufacturer. After one or more code modules have been located in RAM 170, the processor 105 may execute software instructions of the one or more code modules.

Portions of the application program 133 relating to data flow visualization are typically downloaded to the device 101 from a cloud server such as the server 190. Other portions or modules of the application 133 may be typically pre-installed and stored in the ROM 160 by a manufacturer, prior to distribution of the electronic device 101. data storage media, such as an SD card, and read via the portable memory interface 106 of FIG. 1A prior to storage in the internal storage module 109 or in the portable memory 125. In another alternative, the software application program 133 may be read by the processor 105 from the network 120, or loaded into the controller 102 or the portable storage medium 125 from other computer readable media. Computer readable storage media refers to any non-transitory tangible storage medium that participates in providing instructions and/or data to the controller 102 for execution and/or processing. Examples of such storage media include floppy disks, CD-ROM, a hard disk drive, a ROM or integrated circuit, USB memory, a magneto-optical disk, flash memory, or a computer readable card such as a PCMCIA card and the like, whether or not such devices are internal or external of the device 101. Examples of transitory or non-tangible computer readable transmission media that may also participate in the provision of software, application programs, instructions and/or data to the device 101 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the application programs 133 and the corresponding code modules mentioned above may be executed to implement one or more graphical user interfaces (GUIs) to be rendered or otherwise represented upon the display 114 of FIG. 1A. Through manipulation of the user input device 113 (e.g., the keypad), a user of the device 101 and the application programs 133 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 1B illustrates in detail the embedded controller 102 having the processor 105 for executing the application programs 133 and the internal storage 109. The internal storage 109 comprises read only memory (ROM) 160 and random access memory (RAM) 170. The processor 105 is able to execute the application programs 133 stored in one or both of the connected memories 160 and 170. When the electronic device 101 is initially powered up, a system program resident in the ROM 160 is executed. The application program 133 permanently stored in the ROM 160 is sometimes referred to as “firmware”. Execution of the firmware by the processor 105 may fulfil various functions, including processor management, memory management, device management, storage management and user interface.

The processor 105 typically includes a number of functional modules including a control unit (CU) 151, an arithmetic logic unit (ALU) 152, a digital signal processor (DSP) 153 and a local or internal memory comprising a set of registers 154 which typically contain atomic data elements 156, 157, along with internal buffer or cache memory 155. One or more internal buses 159 interconnect these functional modules. The processor 105 typically also has one or more interfaces 158 for communicating with external devices via system bus 181, using a connection 161.

The application program 133 includes a sequence of instructions 162 through 163 that may include conditional branch and loop instructions. The program 133 may also include data, which is used in execution of the program 133. This data may be stored as part of the instruction or in a separate location 164 within the ROM 160 or RAM 170.

In general, the processor 105 is given a set of instructions, which are executed therein. This set of instructions may be organised into blocks, which perform specific tasks or handle specific events that occur in the electronic device 101. Typically, the application program 133 waits for events and subsequently executes the block of code associated with that event. Events may be triggered in response to input from a user, via the user input devices 113 of FIG. 1A, as detected by the processor 105. Events may also be triggered in response to other sensors and interfaces in the electronic device 101.

The execution of a set of the instructions may require numeric variables to be read and modified. Such numeric variables are stored in the RAM 170. The disclosed method uses input variables 171 that are stored in known locations 172, 173 in the memory 170. The input variables 171 are processed to produce output variables 177 that are stored in known locations 178, 179 in the memory 170. Intermediate variables 174 may be stored in additional memory locations in locations 175, 176 of the memory 170. Alternatively, some intermediate variables may only exist in the registers 154 of the processor 105.

The execution of a sequence of instructions is achieved in the processor 105 by repeated application of a fetch-execute cycle. The control unit 151 of the processor 105 maintains a register called the program counter, which contains the address in ROM 160 or RAM 170 of the next instruction to be executed. At the start of the fetch execute cycle, the contents of the memory address indexed by the program counter is loaded into the control unit 151. The instruction thus loaded controls the subsequent operation of the processor 105, causing for example, data to be loaded from ROM memory 160 into processor registers 154, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 133, and is performed by repeated execution of a fetch-execute cycle in the processor 105 or similar programmatic operation of other independent processor blocks in the electronic device 101.

The application 133 receives data from a Twitter Application Programming Interface (“API”) of the server 190 using an application known as Twitter Kit, a part of the Fabric suite of APIs, for interfacing with the server 190. Twitter Kit is a library that provides methods for transmitting requests to a Twitter API executing on the server 190 and receiving a response.

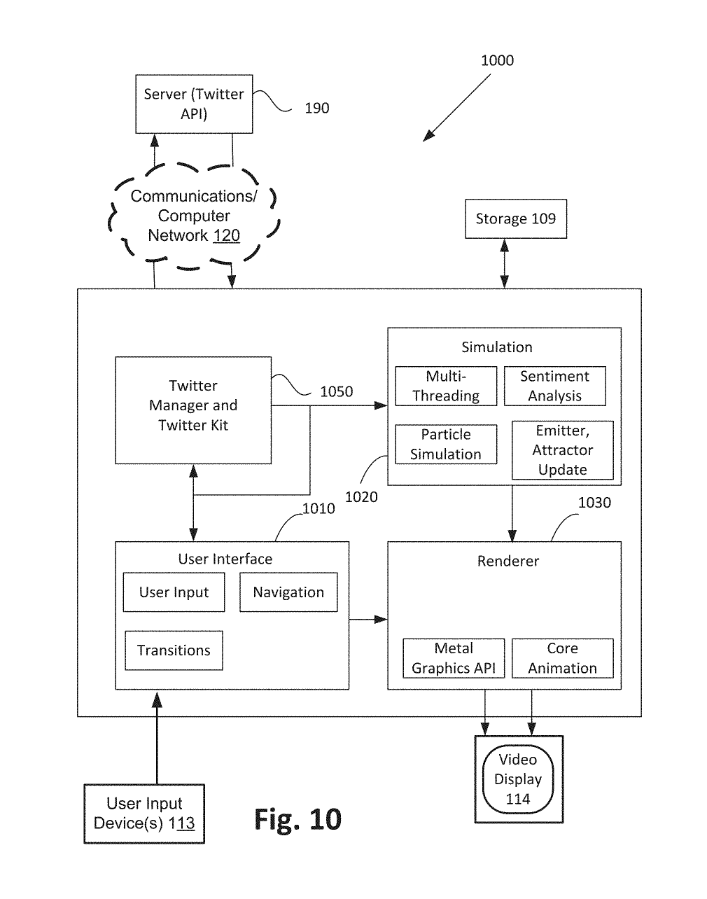

FIG. 10 shows a software architecture 1000 typically used in the application 133 for visualising data flow of Twitter messages. The architecture 1000 includes a Twitter Kit module 1050. The Twitter Kit module 1050 receives data from and transmits data to a user interface module 1010. The Twitter Kit module 1050 transmits requests and queries via the network 120, for example the internet, to the server 190 (which includes the Twitter API), and receives authentication data and JSON data in reply from the server 190. The received JSON data is used to generate the data visualization. The Twitter Kit module 1050 also executes to manage data received, for example using cursoring, to be described below, and any required buffering.

The user interface module 1010 receives user input commands, for example from user input devices 113 of the device 101. The user inputs typically involve interaction by the user with a GUI of the display 114. The architecture 1000 includes a simulation module 1020 configured to generate simulation data and parameters, as described hereafter in relation to FIGS. 2-6. Simulation data and/or parameters generated by the simulation module 1020 can be stored, in some instances temporarily, in the memory 109. Simulation data generated by the module 1020 is passed to a renderer module 1030. The module 1030 is configured to execute graphics and animation programs to reproduce an animation of the simulation on the screen 114.

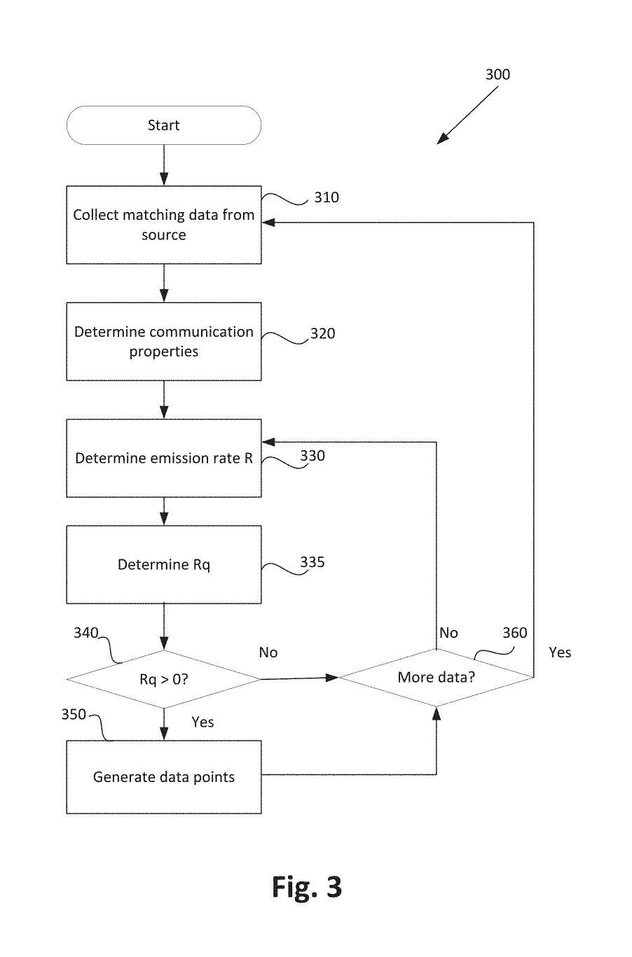

The division of the operation of the application 133 into the methods of FIGS. 3 to 6 and implementation of each of the methods is designed to operate substantially in parallel. The parallel operation allows the computation required to be distributed across multiple threads and CPU cores. The distribution allows the application 133 able to run on smartphone or other portable devices with limited processing capability. The “Multi-Threading” submodule of the module 1020 is responsible for grouping the steps of the methods of FIGS. 3-6 into asynchronous execution units that can be run in parallel on multiple-cores. The multithreading includes dispatching and receiving asynchronous network requests using the “Twitter Manager and Twitter Kit” module 1050, batching the received data into asynchronous execution units that perform the method computations, synchronising so that the results of an asynchronous operations are available when needed and scheduling so that maximum parallelism possible is achieved.

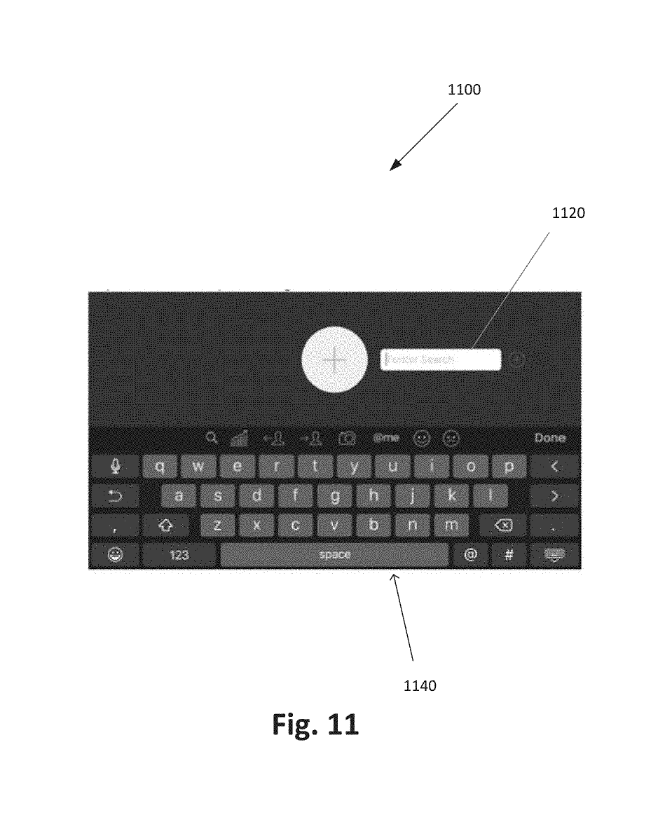

The Twitter API supports a number of types of request, known as “end points”. Each end point returns different data. The application 133 executes to display a GUI to the user via the display 114 of the electronic device 101 by which the user can enter endpoints to generate an emitter. FIG. 11 shows an example image 1100. The image 1100 is a screenshot of a GUI displayed by the device 101 and generated by execution of the application 133. The GUI display 1100 includes a search entry box 1120 and a keyboard arrangement 1140 by which the user can enter a search query for an end point.

The endpoints used in the implementation described include at least “Search”, “Mentions”, “Trends” and “Home Timeline”. “Search” relates to the primary endpoint use and returns tweets matching a search query. “Mentions” returns tweets mentioning a searched identity. “Home Timeline” returns tweets that comprise the “home timeline” of the user. That is, “Home Timeline” return tweets that appear on the user's homepage when the user logs in to Twitter based on who they follow, who has replied to their tweets and other factors determined by Twitter. Additional endpoints include “Like/Unlike”, “Retweet” and “Update”. “Like/Unlike endpoints are used to allow the user to like or unlike a tweet. Retweet is used to allow the user to perform a retweet and Update is used to allow the user to post a new tweet.

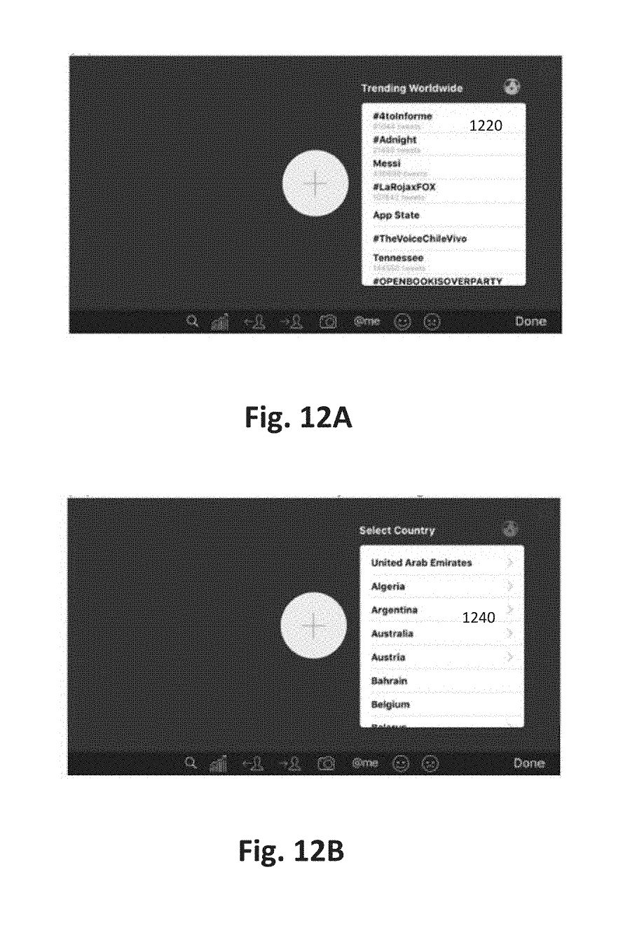

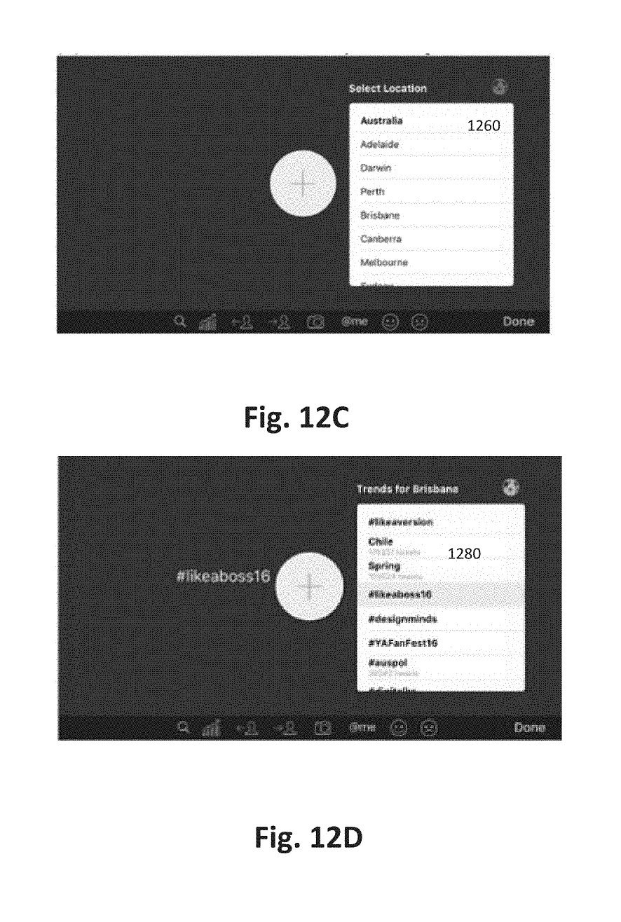

“Trends” return currently trending hashtags for various locations, such as particular cities or countries. FIG. 12A to 12D show a sequence of GUI screenshots, providing an example GUI displays used to determine endpoints for Trends. FIG. 12A includes a selectable list of worldwide trends 1220. The application 133 can receiving a user query relating to a trend via user manipulation of the list 1220 and operate to provide a selectable list of relevant locations to the user, for example as shown in FIGS. 12B to 12D.

FIG. 12B shows a selectable list of countries 1240. FIG. 12C shows a selectable list of locations 1260 associated with a selected country, Australia. FIG. 12D shows a selectable list of trends 1280 in a selected city, Brisbane, in Australia. The user accordingly can select a level (worldwide/country, city etc.) of a trend. Upon receiving a user selection of a location, the application 133 transmits, via the network 120, a request for JSON data describing Twitter messages associated with the selected trend and location.

A specific list of all endpoint addresses, all relative to the Twitter API base is provided in Table 1 below.

TABLE 1

| Endpoint | Address |
|---|---|
| URL | https://api.twitter.com/1.1 |
| Search | /search/tweets.json |
| Mentions | statuses/mentions_timeline.json |
| Update | /statuses/update.json |
| Like | /favorites/create.json |
| Unlike | /favorites/destroy.json |
| Retweet | /statuses/retweet/<tweet_id>.json |
| Trends by Place | /trends/place.json?id=<place id> |
| Available Trends: | trends/available.json |
| Home Timeline | /statuses/home_timeline.json |

In some arrangements, the application 133 queries two endpoints in order to allow the user to select trending hashtags to add to their query in the creating an emitter. The two queried endpoints are the Available Trends and Trends by Place endpoints.

For a Trends query, the application 133 receives a response relating to available trends from the server 190, as shown in FIG. 12A. The response received from the server 190 is a JSON array of places in the (towns, cities, countries) that currently have trending hashtags or searches as determined by Twitter. An example entry for Montreal in Canada is provided below:

{

“name”: “Montreal”,
“placeType”: {

“code”: 7,
“name”: “Town”

},
“url”: “http:\/\/where.yahooapis.com\/v1\/place\/3534”,
“parentid”: 23424775,
“country”: “Canada”,
“woeid”: 3534,
“countryCode”: “CA”

},

The “woeid” field is passed as a parameter to the Trends by a place endpoint. The endpoint returns a JSON response containing the actual trending hashtags or queries for the place, for example “https://api.twitter.com/1.1/trends/place.json?id=3534”.

A further example relating to Trends reads:

{

“name”: “#StanleyCup”,
“url”: “http:\/\/twitter.com\/search?q=%23StanleyCup”,
“promoted_content”: null,
“query”: “%23StanleyCup”,
“tweet_volume”: 14294

},
{

“name”: “Canucks”,
“url”: “http:\/\/twitter.com\/search?q=Canucks”,
“promoted_content”: null,
“query”: “Canucks”,
“tweet_volume”: 11009

},

In the example above, the application 133 uses the “placeType” and “parented” information to group the trending hashtags and entries in the available trends array hierarchically. E.g. “Montreal” will be under “Canada” which has a woeid value of “23424775”. The grouping allows the user to look at worldwide trends, or to drill down into trending hashtags occurring in a specific city or town. The application 133 also caches the responses from the endpoints so as to minimise data usage and avoid being rate-limited by the Twitter API.

The GUI interfaces of FIGS. 11 and/or 12 allow the user to create complex compound queries relating to known Twitter accounts, included and excluded accounts, based upon sentiment and the like. For example, a user may enter data to generate an emitter relating to “tweets containing a photo that were sent by @VanityFair and that have a positive sentiment”, or “tweets that mention @HillaryClinton but not @Trump”. The compound queries are represented visually as the user creates them. The application 133 translates the query the user creates into a request to the Twitter API, mapping the request into an expression comprised of one of a number of endpoints. For example, the query may be translated into an expression comprised of Query operators supported by one of the endpoints. Each compound query represents a particular emitter. An emitter can relate to one or more of a twitter identity, a sentiment, tweets associated with a particular feed, tweets matching one or more keywords, tweets matching a hashtag, or a combination thereof.

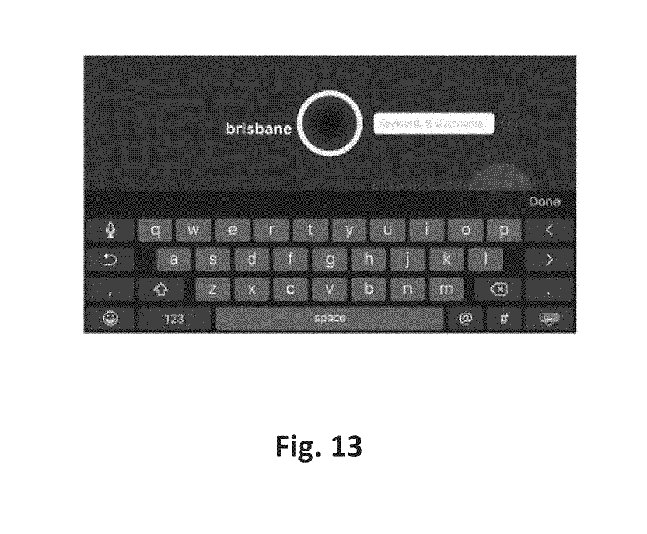

The user may also generate “attractor” in a similar manner. An example screenshot 1300 of a GUI display for the user to search for an attractor is shown in FIG. 13. The GUI display 1300 is generated and operated in a similar manner to the screenshot 1100. An attractor can have one or more associated keywords or phrases. Attractors are counterparts to emitters in that attractors attract or draw in tweets generated or spawned by an emitter. An attractor may also be referred to as an entity that receives rather than emits tweets. An attractor can include tweets mentioning an account of the user of the device 101.

FIG. 2 shows a method 200 of providing a visual representation of Twitter data. The method 200 is typically implemented as one or more modules of the application 133, executed on the processor 105, and stored on the general storage device 109. The method 200 can be implemented using the architecture 1000 of FIG. 10 for example. The modules implementing the method 200 may in some instances be received from the server computer 190 via the network 120.

The method 200 starts at step 210 to identify a data request relating to social media data. Identifying a data request in some instances occurs when the user of the device 101 interacts with the GUI of any of FIGS. 10 to 13 using inputs of the electronic device 101, such as a touch screen or buttons, to request data relating to a particular emitter. The user inputs can be received by the module 1020. For example, the entity may relate to “@DonaldTrump” or a particular hashtag. Alternatively, the data request is identified based upon previously received user instructions relating to an entity such as an emitter or an attractor. In other arrangements, step 210 may relate to identifying an existing request that requires refreshing or update. The application 133 executes to generate a request message for the emitter(s) and attractor(s). The request message can be generated by the module 1050 after receiving data relating to the inputs from the module 1020 for example. The request is typically in a format suitable for HTTP transmission. A request for data is transmitted from the electronic device 101 to the server 190 via the network 120 at the step 210.

The method 200 proceeds from step 210 to a receiving step 220. At the receiving step 220, the application 133 executes to receive a response from the server 190. The response includes data describing Twitter messages, also referred to as tweets. The Twitter messages are describing Twitter messages related to the entity or entities identified in step 210. An example of a request sent to the server 190 for tweets containing the phrase “Ice Cream” that contains images is: “https://api.twitter.com/1.1/search/tweets.json?q=Ice Cream filter:images”. A request for tweets sent by the account @NASA, containing images and mentioning ‘Mars’ is provided by: “https://api.twitter.com/1.1/search/tweets.json?q=Mars filter:images from:NASA”. The requests are generated by the module 1050 upon receiving user input from the user interface module 1010.

The data received from the server 190 is typically in JSON format. An example of a partial response in JSON format received for a search query for the term “Windsurfing” is shown in Appendix A. Apart from requests relating to the endpoint Trends, the data received in the response comprises a set of tweets and a number of associated attributes for each tweet. The attributes associated with a tweet can include the user who authored the tweet, the number of followers the author has, hashtags present within the tweet, and the like. In terms of the message contained in a tweet, each response is typically only partial in that a portion of the total tweet messages is provided. Each tweet received tweet is a fully formed Tweet object, including the tweet message itself as well as associated metadata.

Twitter often cannot send the entire set of tweets in a single response as the response would usually use too much data for efficient or practical implementation. Instead, the server 190 transmits back a subset of all the tweets for a response at a time.

Each subset of tweets is known as a “page”. The application 133 employs a technique known as “cursoring”, supported by the Twitter API, to send further requests to the server 190 for the additional pages until there are none remaining or a predetermined limit is reached for the number of Tweets the application 133 can receive in that particular instance. The predetermined limit may relate to capacity available in the memory 109 for example. In this regard, the method 200 can be executed a number of times in parallel, or repeat a number of times in a looping operation. Cursoring operates in a similar manner to paging. Each tweet received has an associated identification. Cursoring records a greatest identifier of all tweets received at each request, to ensure tweets are not counted twice, or excluded. Cursoring can be implemented by the module 1050.

The method 200 proceeds from step 220 to a determining step 230. At execution of step 230, the application executes to determine relevant communication properties associated with the data received in relation to the user request at the step 210.

As each response is received, the JSON data received is parsed to determine communication properties that are required in relation to the emitter. The properties required relate to the endpoints entered by the user and other information that can be represented in a graphical manner to simulate characteristics of the tweets with respect to the emitter. Relevant communication properties relate to an emission data rate, a subject, and contextual characteristics such as sentiment for example. A method 300 described hereafter in relation to FIG. 3 determines relevant communication properties. The step 210 (and accordingly the method 300) can be implemented by the simulation module 1030.

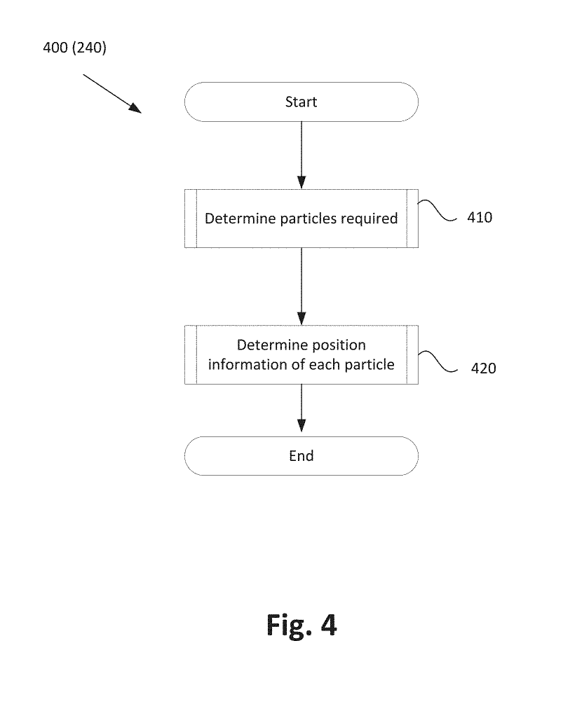

The method 200 continues from the step 230 to a generation step 240. At step 240, simulation parameters associated with the network are determined using the relevant communication properties. The simulation parameters relate to emission rate of the Twitter data associated with an entity. The simulation parameters can also relate to subject, and position of particles emitted by each emitter the resultant simulation. A method 400 of generating simulation parameters, as executed at step 240, is described hereafter in relation to FIG. 4.

The method 200 proceeds from the step 240 to a rendering step 250. Step 250 can be implemented by the module 1030. In execution of the step 250, the simulation is rendered and reproduced for viewing by the user on the device 101 such that the user can view a simulation of the information received from the Twitter Kit. The rendering is implemented using a hardware-accelerated graphics API for an operating system of the device 101 such as OpenGL ES 2.0 or Metal. The render step 240 can include assigning colours to particle movement within a simulation, for example using blue to represent tweets having an overall positive sentiment and red to represent tweets having an overall negative sentiment. In conjunction with the graphics API output, graphical user interface (GUI) elements are displayed using a native operating system GUI API of the device such as iOS Core Animation and UIKit providing interactive elements such as buttons and text labels.

The first few bytes of the internal representation of a particle is laid out in memory such that the particle can be used by both the CPU and the associated graphic processing unit (GPU) with no translation needed. An example structure for a particle is shown below:

struct Particle {

var position = float3( )
var prevPos = float3( )
var color = float4( )
var lineColor = float4( )
var scale:Float = 0
...

In the structure above, the prevPos is the position the particle was at last frame. The prevPos is used by both a verlet integration (to infer velocity) and the particle trail rendering, saving memory and processing power over a scheme that would require the construction of a separate Particle representation specific to rendering.

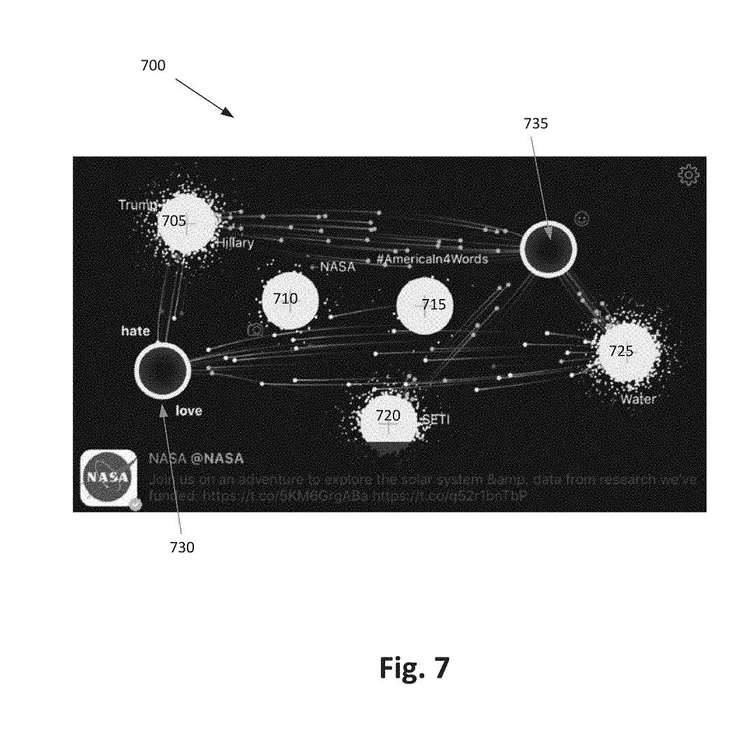

As each particle moves across the display, the particle leaves a trail (see FIG. 7). In the rendering module 1030, the prevPos is used in drawing a long trail behind each particle without the typical approach of needing many vertices to represent the length of the line, which would be costly on a mobile device. To achieve the long tail at decreased computational cost, the renderer draws a small segment of the trail each frame, from the current pos to the prevPos into a separate render target which doesn't get cleared. The render target has a small amount subtracted from each pixel via a blend operation, each frame gradually fading out the lines. This approach allows thousands of trails of arbitrary length to be rendered efficiently on mobile devices with limited GPU power. An example of shader code (Metal) showing how the above particle data can be used to generate the line segments each frame reads:

vertex ProjectedLineVertex vertex_line(constant Particle *vertices
[[buffer(0)]],

constant Uniforms &uniforms [[buffer(1)]],
ushort vid [[vertex_id]],
ushort iid [[instance_id]])

{

// For each vertex (pos, prevPos) in the buffer, we want to generate
four vertices to make
// a line segment of the specified width.
const float thickness = uniforms.linesThickness;
ushort vertIndex = iid;
const Particle particle = vertices[vertIndex];
const float3 pos = particle.position;
const float3 prevPos = particle.prevPos;
float3 line = pos − prevPos;
float3 normal = normalize(float3(−line.y, line.x, line.z));
// Generate vertices to represent this line segment.
float3 verts[ ] = { prevPos − thickness * normal,

prevPos + thickness * normal,
pos − thickness * normal,
pos + thickness * normal };

const int posIndex = vid % 4;
float4 vPos = float4(verts[posIndex], 1.0);
ProjectedLineVertex outVert;
outVert.position = uniforms.viewProjectionMatrix * vPos;
outVert.color = particle.lineColor * uniforms.linesColourMultply;
outVert.texCoords = lineUVs[posIndex];
return outVert;

}

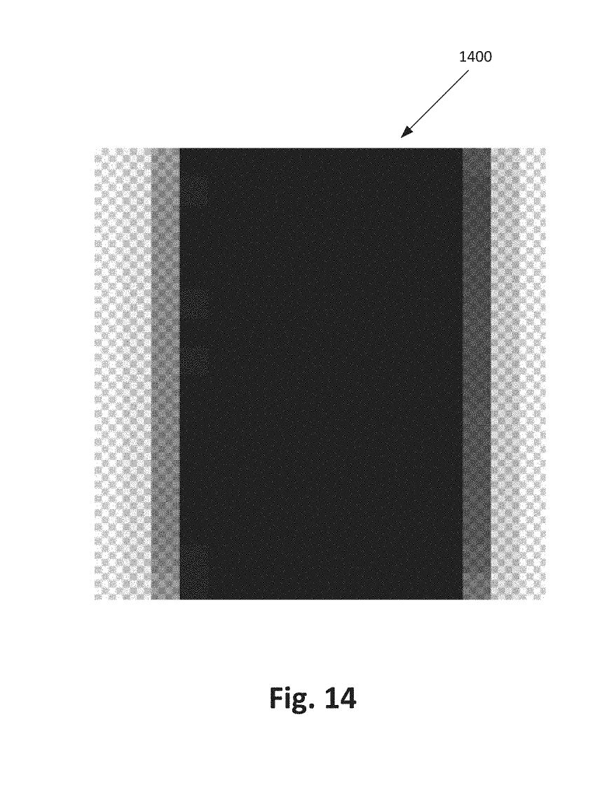

The line segment is actually rendered as a small textured quad. The texture is applied in such a way as to emulate anti-aliasing, giving the lines a smooth appearance without the high cost of a dedicated anti-aliasing process. The emulation of anti-aliasing is another way in which the application 133 allows such a complex visualization to run at interactive framerates on smartphone devices. An example of texture 1400 used by the rendering (inverted and over checkerboard for clarity) is shown in FIG. 14. The method by which the posIndex is determined allows the vertices buffer to contain 4 times fewer vertices, with the additional vertices being generated in the shader itself. The particle rendering (for example dots in FIG. 7) employs similar approaches to avoid anti-aliasing and require 4 times fewer vertices. Both use the same particle data as the simulation on the CPU.

FIG. 3 shows a method 300 of determining relevant communication properties, as implemented at step 230 of FIG. 2. The method 300 is implemented for each emitter E determined from a user search request. FIG. 3 is described in relation to an emitter but can also be implemented for an attractor.

FIG. 3 starts at a step 310. At step 310, data received from the Twitter source that matches the queries related to an emitter is collected by storing the data in association with the emitter. The remote network request to the Twitter API is executed asynchronously and can return data back to step 310 at any time. Effectively, for each emitter E, step 310 executes to collect matching data points d received from the server 190, and adds the data points d to this emitter's total data set D. Each emitter processes and maintains the emitter's own set of received data.

The method 300 proceeds from step 310 to a determining step 320. At step 320, communication characteristics of the Twitter data are determined. The communication characteristics determined include a time range of the tweets relating to the emitter in the list stored at step 310. The step 310 executes to determine a time of an earliest tweet in D (earliestDataPointInTime) and latest data point in time (latestDataPointInTime) and a time span determined according to Equation (1) below. Because the timeSpan is used as a divisor in a subsequent step and because the timeSpan is computed from real-world Tweet data that could occasionally be anomalous, the timeSpan is clamped to be non-zero and within a reasonable range (between 1 year and 0.01 milliseconds) that guards against unrealistically huge or small values.

timeSpan=latestDataPointInTime−earliestDataPointInTime (1)

Each emitter has an actual data point rate dE determined by Equation (2). The rate is referred to as the “actual” rate since the rate is a reflection of the real-world rate of Tweets gathered by each Emitter.

dE=count(D)/timespan (2)

The communication characteristics in some instances can in some arrangements include other data such as data relating to number of retweets, tweet length, author, number of followers, age of tweets and associated hashtags. In some arrangements, the application 133 also determines to execute a sentiment analysis algorithm on the text of each tweet to determine if the tweet is positive, negative, or neutral in tone. The application 133 typically uses a standard sentiment algorithm having a dictionary of approximately 7000 positive and negative words. Each tweet is examined for how many positive or negative words the tweet contains, resulting in an integer score. For example, a tweet with 4 positive and 2 negative words would get a sentiment score of +2. The determined sentiment provides another communication characteristic of the tweet.

The steps 310 and 320 are executed asynchronously (i.e. together on a separate thread) whenever a new batch of tweet data arrives from the server (typically in lots of 100 tweets). The asynchronous completion of the parallel execution on each data point is indicated by an atomic state variable possessed by each data point being set to a “ready” state. Subsequent steps will not process a data point until it is in the “ready” state.

The method 300 progresses to an emission rate calculation step 330 where an emission rate R is determined for each emitter E in a frame. The emission rate is the number of data points per second that should be added to the simulation (and displayed on the screen) from each emitter.

The maximum and minimum actual data point rates for the set of all Emitters are determined using Equations (3) and (4) respectively. Equations (3) and (4) are executed as a pre-step over the set of all Emitters, with the resulting min_dE and max_dE being passed to the per-emitter calculations beginning with equations (5).

Min_dE: ∀E, min_dE<=E.dE (3)

max_dE: ∀E, max_dE>=E.dE (4)

The dE values of emitters may change asynchronously as step 320 is re-triggered by the receiving of more data. Emitters may also be deleted by the user at any time. As such, the step 330 is re-evaluated for each frame.

A relative emission rate rate L is calculated using Equation 5:

L=dE−min_dE/(max_dE−min_dE) (5)

Determining simulation parameters also relates to calibrating a spawn rate or emission rate of the particles in the simulation. Calibration is particularly important when a number of emitters and/or attractors are being used. A function is typically applied to the relative rate L (Equation (6)) to adjust the response curve across the range of dE, for example to produce more or less differentiation over certain areas of the range. The response curve is typically adjusted to make emitters having relatively lower emission rates more easily visually differentiated from emitters having relatively high emission rates. For example an inverse quadratic function would increase differentiation over the lower end of range and compress the higher end. Other examples include a linear response or a soft knee compression.

fL=responseFunction(L) (6)

Adjustment of the response curve can, for example, increase clarity to a viewer of the simulation of whether an emitter A has a higher emission rate than an emitter B, even when both emitters A and B have relatively low emission rates compared to all other emitters being displayed on the screen 114. The emission rate R of each emitter is recalculated by the application 133 as emitters are created or deleted and as they receive new tweets. In order to give a consistent visual comparison, the emission rate of each emitter or entity in the simulation needs to be correct relative to emission rates of all other entities in the simulation. Implementing correct relative emission rates allows the user to quickly determine from a visual appraisal of the simulation which entities have higher and lower volumes. The user can also visually determine those entities which have the highest rates of data flow. The application 133, using the emission rate calculation, dynamically renormalises all emission rates as needed as these occur to keep the visual comparison valid. In other words, the emission rate of each emitter is constantly updated to ensure that there is a visual consistency in emission rate across all emitters, so that it is valid and straightforward to visually compare the particle output of each Emitter as an indication of the relative number of tweets that originally occurred in the Twittersphere relating to the emitter's query and the relative rate at which those tweets were originally posted. The application 133 can also apply non-linear scaling so that emitters with smaller tweet counts are more visually differentiated.

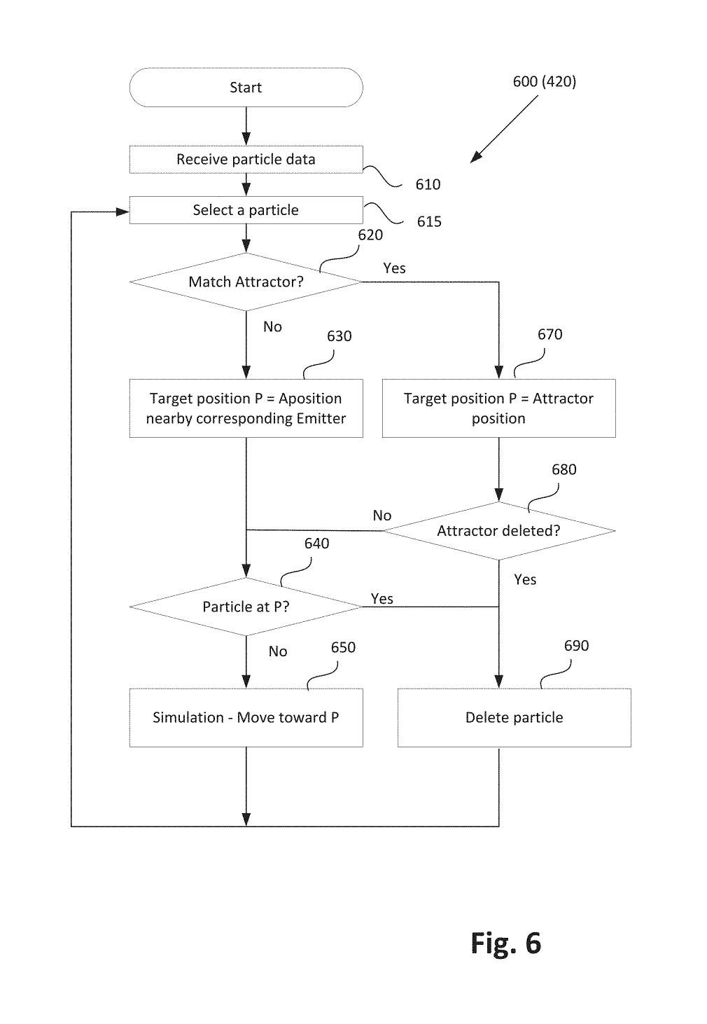

In determining the rate R, an intrinsic rate of tweets I is determined for the emitter E using I=count(D)/F, where F is the average number of seconds that a non-attracted particle is illustrated in a simulation before being deleted, as discussed in relation to FIG. 6. Thus the intrinsic rate I is the approximate emission rate required to have all particles associated with the Emitter E visible in the simulation at one point in time.

The final emission rate R for the emitter E is determined by interpolation between I and fL as per Equations (7) to (9). The rate R is determined by this interpolation because for real-world tweet data a small count (D) may result in an inaccurate L.

rateDifference=I<fL? fL−I:0 (7)

rateLerp=smootherStep(edge0: RATE_LOW_THRESHOLD, edge1: RATE_HIGH_THRESHOLD, t: rateDifference) (8)

R=lerp(from: fL, to: I, amount: rateLerp) (9)

Rq=quantisedElapse(R) (10)

The method 300 proceeds from step 330 to a further determining step 335. In execution of step 335, the real-valued emission rate is converted to an integer using a quantised elapse algorithm (quantisedElapse) described below, as per Equation (10) above. Using the quantised elapse algorithm gives a discrete integer value Rq corresponding to how many data points should be emitted as particles by this emitter in a frame.

In equations (7) and (8) above, thresholds RATE_LOW_THRESHOLD and RATE_HIGH_THRESHOLD are typically predetermined. In one example of generating a rate R, if the list D contains a thousand tweets, and the oldest and youngest tweets in the list are six minutes apart, the application 133 may determine a tweet rate R of 3.33 tweets per second. The determination of the sentiment (at step 320) and the overall tweet rate (330) may be executed asynchronously. The thresholds RATE_LOW_THRESHOLD and RATE_HIGH_THRESHOLD can be determined via experimentation. Preferably, a value of 2.0 is used for RATE_LOW_THRESHOLD and a value of 10.0 used for RATE_HIGH_THRESHOLD.

The method 300 proceeds from the step 335 to a check step 340. At step 340, the application 133 determines if the discrete emission rate Rq determined at step 335 is greater than zero. If the emission rate Rq is greater than zero (“Y” at step 340), the method proceeds to step 350. At step 350, data points relating to the relevant emitter are generated. The number generated being equal to the value Rq previously calculated for the emitter. Each data point generated is linked to a tweet received by the emitter. From step 350, the method 300 proceeds to a check step 360. At step 360, the application 133 determines if more received data is available. If more data is not available (“No” at step 360), the method proceeds back to step 330. Otherwise, if more data is available (“Yes” at step 360) the method 300 returns to step 310. If at step 340 the rate Rq is 0 (“No” at step 340), the method proceeds to step 340 to step 360.

The method 300 is implemented for each emitter. Typically, a number of instances of the method 300 are implemented simultaneously for each of the emitters. Steps 310 and 320 are executed asynchronously for each emitter when new tweets have been received from the server 190 and need to be processed. For example, tweets may be received in groups of 100 as JSON responses, and the batch of tweet data is processed by the steps 310 and 320 running as an asynchronous unit of work, potentially on a separate thread.

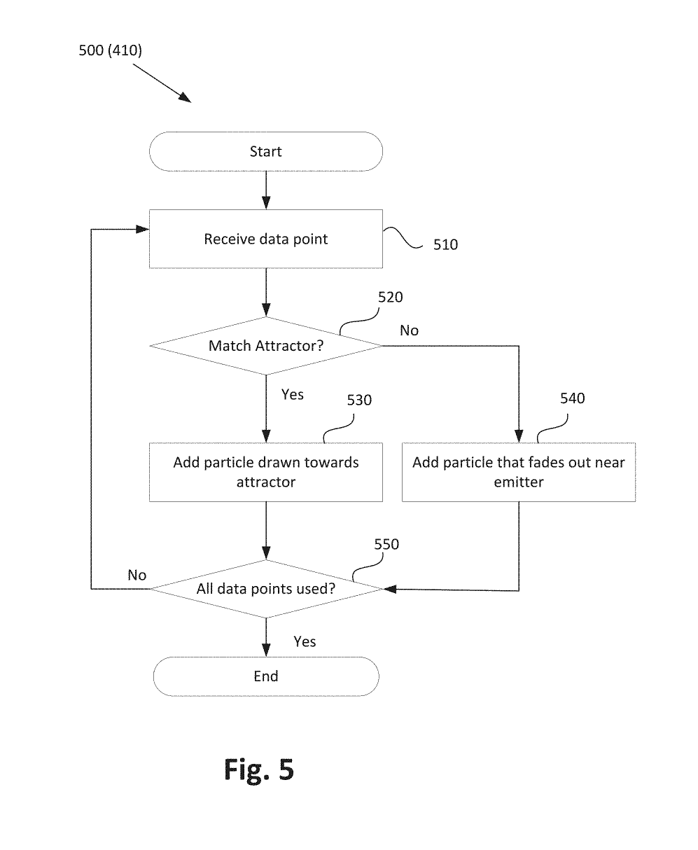

Steps 330 and 350, along with methods 500 and 600 of FIGS. 5 and 6, in that order, can be grouped together into an asynchronous execution unit (i.e. run together on a separate thread). The asynchronous execution unit can be scheduled to run at the beginning of each frame and then synchronised as late as possible in the particle renderer, immediately before the updated simulation data resulting from the method 600 is needed for rendering the frame. Other techniques can be applied here to achieve greater parallelism such as double-buffering so that these steps or methods have up to two frames of time to complete, as would be appreciated by a person skilled in the art.

FIG. 4 shows the method 400 of generating simulation parameters, as implemented at step 240 of FIG. 2. The method 400 is implemented for each simulation particle d that is emitted by an emitter E.

The method 400 starts at a determining step 410. The step 410 receives the data points generated in FIG. 3, associated with each emitter and proceeds in relation to a first or next data point. The step 410 determines what particles are required in the simulation in this regard. A particle in the context of the present disclosure relates to a visual representation of a data point in a simulation. For example, a particle can be represented by a circular shape spawned or emitted from a representation of an emitter. A particle is associated with simulation parameters relating to position within a display of the simulation and movement within the display of the simulation.

The method 410 proceeds from step 410 to a determining step 420. Step 420 executes to determine additional information of each particle for the emitter to be included in a simulation display provided to a user. After execution of step 420, the method 400 ends.

FIG. 5 shows a method 500 of determining particles required, as implemented at step 410 of FIG. 4. The method 500 is implemented for each data point determined in FIG. 3.

The method 500 operates on each member of the set of data points output from step 350 of method 300, as received at a step 510. The method 500 proceeds from step 510 to a step 520. At step 520, the application 123 determines if the data point, which is known to relate to a particular emitter, also matches an attractor.

If the data point matches the attractor (“Yes” at 520), the method 500 proceeds to step 530. Step 530 executes to add a particle which is drawn towards the attractor in a simulation. A parameter relating to the added particle is stored in a temporary portion of the memory 109. The method 500 proceeds from step 530 to 550. At step 550, a check is run to determine if all data points have been used. If points are used (“Yes” at step 550), the method 500 ends, otherwise (“No” at step 550) the method 500 returns to step 510. If the emitter does not match an attractor at step 520 (“No” at step 520), the application 133 determines that a particle that fades out by the emitter is required at step 540. The method proceeds from step 540 through step 550.

FIG. 6 shows a method 600 of determining position information relating to each particle, as implemented at step 420 of the method 400. The method 600 begins at a step 610 at which particle data generated at step 410 (using the method 500) is received.

The method 600 progresses from step 610 to a select step 615. At select step 615 one of the particles is selected. The method 600 progresses from step 615 to a check step 620. At step 620, the application 123 executes to determine if the received particle data matches an attractor. If the particle data does not match an attractor (“No” at step 620), the method 600 progresses from 620 to a step 630. At execution of the step 630, a target position P of the particle is chosen to be a random position within a relatively small radius of the associated emitter position. The associated emitter is the emitter that spawned the selected particle. Some particles may relate to more than one emitter. If a particle relates to more than one emitter, step 630 is repeated for the particle for each emitter.

A method 600 progresses from the step 630 to a check step 640. At execution of the step 640, the application 133 executes to determine if the particle has arrived at the target position P. If the particle has arrived at point P (“Yes” at step 640), the method 600 progresses to a step 690. The target position P represents a position towards which the particle will move over time. This motion will be made visible on the display when the particle data is rendered.

If at step 640, the application 133 determines that the particle is not at position P (“No” at 640), the method 600 progresses to a physics simulation step 650. The physics simulation step 650 will move the particle towards the target position P over time. Thus particles spawned by step 640 will travel a radially out from the emitter position for a short distance before fading out and being deleted. FIG. 7 shows particles approaching 735 as an example of particles moving towards a position. Physics simulation step 650 applies calculation to the particle such that the particle is moved in the display as if gravitationally attracted towards the target position P. Step 650 operates to calculate the change in acceleration, velocity and position of each particle. Step 650 effectively simulates Newtonian dynamics applied with Verlet integration to achieve the calculated particle motion in an efficient manner capable of being run at interactive frame rates by the device 101. The method 600 progresses from step 650 to step 615 to select another particle.

If, at step 620, a particle data is found to match an attractor (“Yes” at 620), the method 600 progresses to a setting step 670. At step 670, a target position P related to the particle is set to the attractor position within the corresponding display. The method 600 progresses from step 670 to step 680. At step 680, the application 133 determines if the attractor has been deleted from the simulation. The user can add or delete emitters or attractors at any time. If the attractor has been deleted (“Yes” at 680), the method 600 progresses to deleting step 690. At the step 690, the simulation parameters are set to delete the particle from the simulation. The method 600 progresses from step 690 to 615. If at 680 the attractor has not been deleted (“No” at step 680), the method 600 progresses to the step 640. Some particles may relate to more than one attractor. If a particle relates to more than one attractor, the steps 670 to 680 are repeated for the particle for each attractor.

The steps of the method 600 between the step 620 to loop back to step 615 forms a number of alternative paths. The method 600 executes to repeat a relevant set of steps from step 620 to step 615 for each particle received at step 610. The method 600 effectively operates to generate simulation parameters relating to movement of particles relative to entities (emitters or attractors). The parameters relate to movement of the particles in a display area at the rate R to a position P associated with each particle.

The application 133 executes to receive data until the emitter query returns no more tweets or reaches an internal limit for the number of tweets and emitter can emit. The internal limit is usually predetermined and can relate to operating parameters of the device 101 through testing a maximum number of data points or particles that the device can process or display at interactive framerates. The internal limit needs to be a constant, known in advance to the software before execution begins so that contiguous fixed sized buffers can be allocated to hold the tweet and particle data. Using a constant limit gives improved locality of reference and thus better cache performance. Improved cache performance is generally an important consideration on mobile devices. Updates are received at predetermined intervals, and, depending on the intervals and processing capabilities of the device 101, can provide real-time indication of rate of tweet data. The indication can include information relating to context (for example using blue for positive sentiment and red for negative sentiment) and direction (or example if the tweets relate to an attractor).

The application 133 preferably groups the device 101 into one of two categories depending on parameters of the embedded controller 102, such as “fast” and “slow” based on an internal database mapping device model numbers to processing speed. The application 133 will receive updates at a different frame rate for slower devices (e.g. 30 Hz) than for faster devices (e.g., 60 Hz). Accordingly, slower devices are afforded more time to execute steps of the methods of FIGS. 2 to 6. At each frame or time step in simulation, the application determines how many particles should be added to the simulation for each emitter so as to accurately reflect the determined emission rate.

The final step in the emission rate calculation described above is the quantised elapse calculation. An example of generating a quantized elapse rate, that is a relative rate can be determined by determining a current time and a time since a non-zero rate count was determined. An ideal interval, being the inverse of the measured rate R is set. The current time is divided into fractional and integer parts. When necessary, a counter is incremented to account for quantising an integer count based on the integer and fractional parts. The counter is used to average out the rate over time.

Determining the quantised elapse rate is important because a continuous (real number) emission rate value needs to be integrated by the application 133 which updates discretely. For each discrete timestep in the simulation, the quantised elapse algorithm is used by each emitter to calculate how many particles are to be added to the simulation so as to accurately match the calculated emission rate. In other words, over time the integral number of particles emitted per frame will average out to match precisely the real-valued emission rate. To summarise, the quantised elapse is particularly suitable for the arrangements described because:
The timestep is a discrete event (and of slightly varying frequency)
The Emission Rate is a real number (also varying)
The number of particles that can be emitted each timestep is a discrete integer value

For example, if the emission rate is 3.4 the application 133 will not determine simulation parameters that emit 4/10ths of a particle. The resultant simulation must emit either 3 or 4 particles (a discrete number), but do so in such a way that over many timesteps the average number of particles emitted will equal 3.4, even if the timestep frequency varies. Pseudocode of the quantized elapse rate algorithm is provided below, where rate is the target (real number) rate (e.g. 3.4) per timestep, and count is the determined discrete number to emit for the timestep. The pseudocode function below measures the time since the function was last called and then randomises between the current and next integers such that the average will exactly equal the target rate.

function quantisedElapse(rate: Double, inout lastTriggerTime: DateTime)
returns Integer {

now = currentTimeMilliseconds( )
elapsed = timeIntervalBetween(lastTriggerTime, now)
idealInterval = 1 / rate
(integer, frac) = modf(elapsed / idealInterval)
count = integer
if count > 0 {

if random(0, 1) < frac {

count += 1

}
lastTriggerTime = now

}
return count

}

FIG. 7 shows an image 700. The image 700 is a screenshot of a GUI display on the user device 101 generated by execution of the application 133. The image 700 shows an example of simulation or visualization of Twitter data using the arrangements described. The image 700 includes emitters 705, 710, 715, 720 and 725, each emitter being represented in the example of FIG. 7 by a circle. The emitters 710 and 720 relate to particular Twitter accounts, being NASA and SETI respectively. The emitters 715 and 725 relate to content referenced in the tweet messages received from the server 190, being the terms “#AmericaIn4Words” and “Water”. The emitter 705 relates to a combination of content referenced in the tweet messages, being occurrence of both “Hillary” and “Trump”.

The image 700 also includes attractors 730 and 735, being sentiment indicators. The attractor 830 relates to tweets that relate to strong emotions such as hate or love. The attractor 735 relates to a happy sentiment, as indicated by use of colours. For example, blue can be used to represent tweets with positive sentiment, red to represent tweets with negative sentiment, and white to represent tweets with neutral sentiment (as determined based on the sentiment score described in relation to step 320 of FIG. 3). Particles are emitted by each indicator at the appropriate rate R determined for each emitter at step 330, which is converted to a discrete per-frame emission rate Rq by step 335. Some particles, e.g., to the right side of the emitter 725 for “Water” fade away or are deleted after travelling a certain distance as these are not matched by any attractor, as determined at step 540. Other particles are spawned from the emitter 705 to the attractor 730 at the rate R determined for each emitter at step 330, which is converted to a discrete per-frame emission rate Rq, as described in relation to step 335. In the example of FIG. 7, the attractor 730 relates to keywords rather than a sentiment filter indicated by an emoticon. However, the attractor 735 attracts only tweets relating to a positive sentiment as indicated by use of an emoticon “©”. Similar mechanisms for indicating sentiment can be used for emitters.

FIG. 7 also relates to the importance of calibration of spawn rates of particles in the simulation. Using calibration to adjust relevant rates, the user can validly visually compare the density and/or speed of tweets from the emitter labelled “water” compared to the emitter labelled “NASA” for example.

A user viewing the GUI display relating to the image 700 can intuitively understand the direction and general relative amount and rate of tweets associated with each emitter. The user can also intuitively understand the approximate proportion and rate of tweets for each emitter associated with one of the attractors 730 and 735. In some arrangements, the user can alter positions of each emitted within the simulation, e.g., to move the emitter 725 closer to the emitter 820. The user implements such a change by selecting and dragging the emitter 825 on a touchscreen display for example. The relative position and trajectory of the particles being emitted by the emitter 825 is updated by determining the position P as per the method 600.

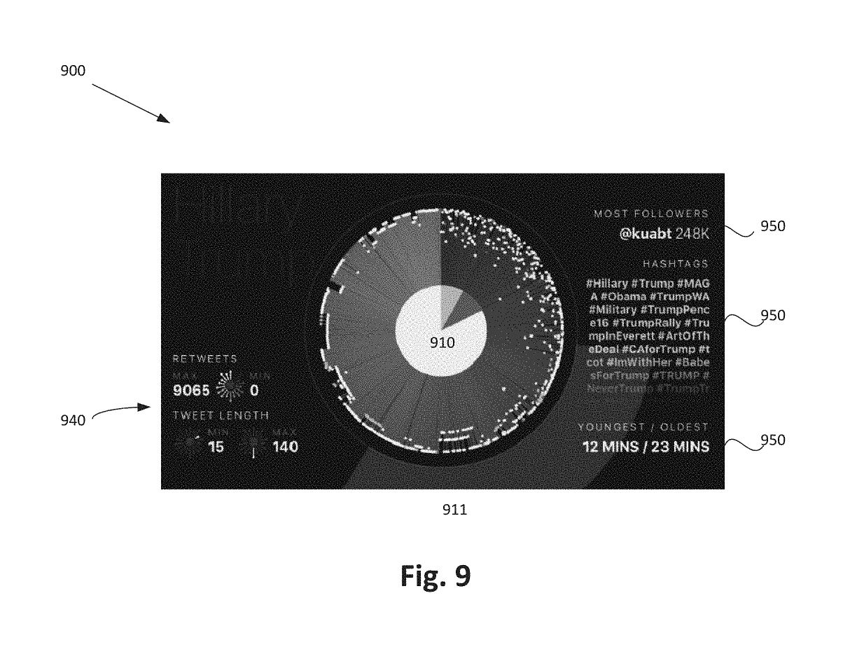

FIG. 7 shows an image from a simulation or visualization of twitter data including a number of emitters and attractors. FIG. 9 shows an image 900. The image 900 is a screenshot of a GUI display on the user device 101 generated by execution of the application 133 in an instance where the user has entered a single emitter query only. In the example of FIG. 9, a single emitter 910 is generated and displayed in the image 900. The emitter 910 relates to the terms “Hillary” and “Trump” and emits associated particles 911. The image 900 includes data associated with the Twitter data received from the server 190 (as determined at step 320), including indication of number of followers 950, hashtags 920 used in as determined at step 320) and information related to retweets as shown in an area 940.

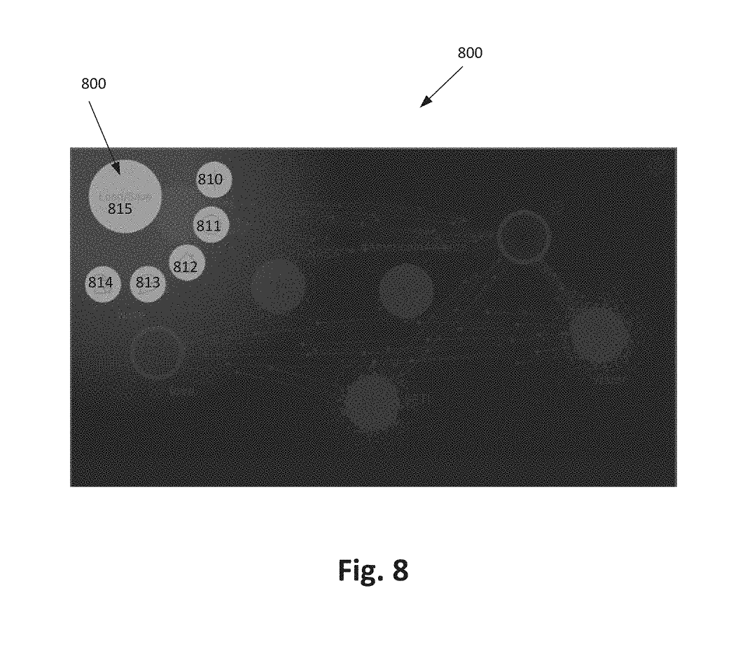

FIG. 8 shows an image 800. The image 800 is a screenshot of a GUI display on the user device 101 generated by execution of the application 133. The screenshot 800 includes a menu area 810, referred to as a radial menu. For ease of recognition of the menu 810, other elements of the image 800 including emitters and the like are faded. The radial menu is responsive and can be displayed on any part within a GUI display. The radial menu 810 is typically manipulated and moved by the user using the touch screen arrangement of the electronic device 101. Presentation of the menu 810 varies within the GUI display depending on position thereof. A size of the menu 810 is be automatically adjusted by the application 133 to fit an appropriate area within the GUI display. Near corners and edges of the GUI display the application 133 executes to adjust submenu items such as menu items 811 to 815.

The dynamic flow of particles in the simulation from emitters to attractors (e.g. FIG. 7), or simply from emitters (e.g. FIG. 9), provides a user with a visualization of data by which the user can quickly and intuitively determine which entities are associated with higher and lower volumes of Twitter traffic. The user is also provided with clear indication of sentiment and subject of data flow. The direction of travel of a particle from an emitter to an attractor provides indication of a subject or sentiment of Twitter data associated with the emitter. The arrangements described accordingly take large amounts of data in which important informational elements are not generally apparent, and provides a clear visual indication to the user. The data visualization effectively provides a simulation of data flow, direction and relative speed. This important information relating to various entities relative to one or another is derived from large, otherwise unreadable sets of data normally available to a user. The user can customise the emitter and attractor data such that information specific to their interests is determined and simulated in near real time in a manner that is easily understandable. The visual comparison available to the user across the simulation is further useful as the emission rate of each emitter is quantized to be correct relative to determined rates for other emitters in the simulation (step 430).

The arrangements described facilitate determination of important and meaningful information, patterns and connections in large data sets that are not reflected in other social media to products. The simulation method of representing the data provides an intuitive and useful alternative to a standard “search and scroll” or listing approaches. The end points described assist in creating complex queries without requiring complex user input. The techniques described in relation to FIGS. 2 to 6 can be used to determine meaningful data characteristics from large quantities of information that have not been identifiable using existing social media tools. The meaningful data characteristics allow the user to recognize flow of data and relative emission rates of each emitter entity.

Further, the arrangements described are particularly suitable to handheld devices. The suitability firstly relates to how the simulation parameters are rendered as particles. Further, operation of the software architecture 1000 is particularly suitable for devices with limited processing capabilities. As described above, the application 133 can classify the device 101 as “fast” or “slow” and adjust frame rates accordingly.

The overall mechanism of the visualization—that of showing dynamic flows of data between emitters and attractors—is important in the suitability of the arrangements described to portable devices such as smartphones. The visualization approach described allows large numbers of data points to be simulated, displayed and analysed in a rapid manner by the user on devices of limited screen size, while also allowing complex queries and multiple simultaneous relationships between data points to be presented intuitively.

The visualization approach is designed to leverage natural human perceptual ability to easily recognise patterns in groups of objects in motion, resultantly producing less cognitive load and an easier feel than traditional approaches to presenting large data sets with complex relationships. Accordingly, larger volumes of data can be presented on smaller screens such as those on smartphone devices.

An important aspect of the visualization approach is the presentation of data points as particles that flow across the screen. Presentation of data points as particles is also important to run the arrangements described on portable devices such as smartphone devices. From a computational standpoint, the particle simulation involves running the same set of instructions on each of a large number of data points. As such, the arrangements described map naturally and efficiently onto the CPU and GPU architectures of modern mobile devices. In particular, architectures of mobile devices are typically performance-sensitive to code that contains a lot of branching. The particle simulation of the arrangements described are typically designed so that complex branching tests are eliminated and refactored into code that achieves a same outcome with branchless operations, so that the CPU and GPU can execute very efficiently. In addition, the particle simulation computation of the invention can be expressed using highly-efficient SIMD instructions that are available on most modern smartphone CPUs. This special class of CPU instructions have the characteristic of delivering more computation per CPU cycle. These aspects described have an added benefit on mobile devices of using less battery.

The verlet integration used to perform the physics simulation step 650 has a benefit of inferring velocity from the previous particle position. Inferring velocity allows the rendering module to use the same particle buffer for rendering as the CPU uses for simulation with no translation required, with the single buffer being used for rendering both the particles and the trails. Using a single buffer saves both CPU and RAM. Accordingly, the visualization arrangements can be implemented as a particle simulation to run on portable or smartphone devices.

The ability of the method and steps of the application 133 to be divided in a parallelisable way forms an important guiding design principle, and is in turn both informed and informed by the specific design of the visualization as a simulation of particles that flow from emitters to attractors.

Mobile devices are also limited in network data usage, often due to the relatively high cost of mobile data. Limitations in network data usage can also be addressed by design aspects of the application 133. The application 133 receives tweet data up to a predetermined limit for each emitter query, and then cycles through this fixed of amount data continuously. This gives a statistically significant sampling of the query response without needing to constantly stream in more data. The user can choose to refresh all queries at any time. In this way the invention is able to run on smartphone/portable devices through a design that overcomes the key limitations of small screen space, RAM, CPU power, GPU power, battery life, and network data usage.

The arrangements described are applicable to the computer and data processing industries and particularly for the social media metric and analysis industries.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

### APPENDIX A

Below is a partial response from the Twitter API search endpoint, with the search query set to “Windsurfing”. The snippet includes the first “status” (Tweet), and the search metadata at the end of the response. In practice the application 133 issues subsequent requests using the search metadata information to continue receiving more Tweets for the search query.

{
“statuses”: [
{
“created_at”: “Tue Feb 28 07:03:02 +0000 2017”,
“id”: 836471757611597800,
“id_str”: “836471757611597827”,
“text”: “Carbon Art is extremely pleased to announce our new partnership with Black Project
Windsurfing\nThat's right -... https://t.co/0tHYfy7LlX”,
“truncated”: false,
“entities”: {
“hashtags”: [ ],
“symbols”: [ ],
“user_mentions”: [ ],
“urls”: [
{
“url”: “https://t.co/0tHYfy7LlX”,
“expanded_url”: “http://fb.me/1WieBNgYo”,
“display_url”: “fb.me/1WieBNgYo”,
“indices”: [
113,
136
]
}
]
},
“metadata”: {
“iso_language_code”: “en”,
“result_type”: “recent”
},
“source”: “<a href=“http://www.facebook.com/twitter” rel=“nofollow”>Facebook</a>”,
“in_reply_to_status_id”: null,
“in_reply_to_status_id_str”: null,
“in_reply_to_user_id”: null,
“in_reply_to_user_id_str”: null,
“in_reply_to_screen_name”: null,
“user”: {
“id”: 23571523,
“id_str”: “23571523”,
“name”: “Carbon Art Boards”,
“screen_name”: “carbonart”,
“location”: “Everywhere, based in NZ”,
“description”: “”,
“url”: “http://t.co/twYgmYw3bz”,
“entities”: {
“url”: {
“urls”: [
{
“url”: “http://t.co/twYgmYw3bz”,
“expanded_url”: “http://www.carbonart.co.nz”,
“display_url”: “carbonart.co.nz”,
“indices”: [
0,
22
]
}
]
},
“description”: {
“urls”: [ ]
}
},
“protected”: false,
“followers_count”: 454,
“friends_count”: 140,
“listed_count”: 10,
“created_at”: “Tue Mar 10 08:45:49 +0000 2009”,
“favourites_count”: 10,
“utc_offset”: −36000,
“time_zone”: “Hawaii”,
“geo_enabled”: false,
“verified”: false,
“statuses_count”: 652,
“lang”: “en”,
“contributors_enabled”: false,
“is_translator”: false,
“is_translation_enabled”: false,
“profile_background_color”: “FFFFFF”,
“profile_background_image_url”:
“http://pbs.twimg.com/profile_background_images/120182960/2011-lineup.jpg”,
“profile_background_image_url_https”:
“https://pbs.twimg.com/profile_background_images/120182960/2011-lineup.jpg”,
“profile_background_tile”: false,
“profile_image_url”:
“http://pbs.twimg.com/profile_images/92298825/Picture_5_normal.png”,
“profile_image_url_https”:
“https://pbs.twimg.com/profile_images/92298825/Picture_5_normal.png”,
“profile_banner_url”: “https://pbs.twimg.com/profile_banners/23571523/1428386806”,
“profile_link_color”: “1F98C7”,
“profile_sidebar_border_color”: “C6E2EE”,
“profile_sidebar_fill_color”: “DAECF4”,
“profile_text_color”: “663B12”,
“profile_use_background_image”: true,
“has_extended_profile”: false,
“default_profile”: false,
“default_profile_image”: false,
“following”: false,
“follow_request_sent”: false,
“notifications”: false,
“translator_{—}
}

1. A method, comprising:
receiving, via a network, data describing Twitter messages related to one or more entities;
determining one or more communication characteristics of the data for each of the one or more entities;
generating simulation parameters for each of the one or more entities, the simulation parameters relating to emission rates of the data corresponding to each of the one or more entities, the simulation parameters being determined from the one or more communication characteristics; and
implementing a simulation reflecting data flow of the Twitter messages for each of the one or more entities at the determined emission rates using the simulation parameters.

2. The method according to claim 1, wherein the determined communication characteristics relate to one or more of number of retweets, Twitter message length, author, number of followers, age of Twitter messages, and associated hashtags.

3. The method according to claim 1, wherein determining one or more communication characteristics of the data comprises determining a sentiment associated with the Twitter messages.

4. The method according to claim 1, wherein the determined one or more communication characteristics of the data includes a mean rate of emission of Twitter messages related to each of the one or more entities.

5. The method according to claim 1, wherein determining the simulation parameters comprises determining a plurality of simulation particles for the Twitter messages, each of the simulation particles associated with one of the one or more entities.

6. The method according to claim 5, wherein the simulation particles are illustrated during implementation of the simulation in an order in which the Twitter messages of the data were transmitted.

7. The method according to claim 5, wherein determining the simulation parameters further comprises determining positional information of each of the simulation particles within the simulation.

8. The method according to claim 5, wherein Twitter messages are related to the at least one entity of the one or more entities by emission from or attraction to the at least one entity.

9. The method according to claim 5, wherein generating the simulation parameters further comprises determining if each simulation particle is associated with two of the one or more entities, and generating simulation parameters of the simulation particles between the associated two entities.

10. The method of claim 9, further comprising determining that one of the simulation particles is associated with the two entities, and generating simulation parameters to display corresponding simulation particles travelling to each of the two entities in the simulation.

11. The method according to claim 9, further comprising determining that one of the simulation particles is associated with one entity only, and generating simulation parameters to illustrate the simulation particle travelling outwardly from the entity.

12. The method according to claim 1, wherein generating the simulation parameters further comprises dynamically normalizing emission rates for each of the one or more entities relative to one another, such that the simulation particles reflect relative data flow of the Twitter messages.

13. The method according to claim 1, wherein determining one or more communication characteristics of the data comprises determining a sentiment associated with each Twitter message of the data; and
determining the simulation parameters comprises determining a plurality of simulation particles, each particle associated with the sentiment of a corresponding Twitter message, the simulation parameters configured to display indication of the sentiment associated with each simulation particle.

14. The method of claim 13, wherein the indication of the sentiment associated with each simulation particle comprises one of a color of the simulation particle or an entity of the one or more entities to which the simulation particle travels in display of the simulation.

15. The method according to claim 1, further comprising:
receiving a user query relating to a trend;
providing a selectable list of relevant locations to a user; and
upon receiving a user selection of a location, transmitting, via the network, a request for data describing Twitter messages associated with the trend and the selected location.

16. A computer readable medium having a computer program stored thereon, the program comprising:
code for receiving, via a network, data describing Twitter messages related to one or more entities;
code for determining one or more communication characteristics of the data for each of the entities;
code for generating simulation parameters for each of the one or more entities, the simulation parameters relating to emission rates of the data corresponding to each of the one or more entities, the simulation parameters being determined from the one or more communication characteristics; and
code for implementing a simulation reflecting data flow of the Twitter messages for each of the one or more entities at the determined emission rates using the simulation parameters.

17. A handheld device, comprising:
a display;
a memory;
a processor, wherein the processor is executes code stored on the memory for:
receiving, via a network, data describing Twitter messages related to one or more entities;
determining one or more communication characteristics of the data for each of the one or more entities;
generating simulation parameters for each of the entities, the simulation parameters relating to emission rates of the data corresponding to each of the one or more entities, the simulation parameters being determined from the one or more communication characteristics; and
reproducing, on the display, a simulation reflecting data flow of the Twitter messages for each of the one or more entities at the determined emission rates using the simulation parameters.
